(19) United States
(12) Patent Application Publication
(10) Pub. No.: US 2003/0061796 A1
(43) Pub. Date: Apr. 3, 2003

(54) Power generating plant

(76) Inventors: Kazuyoshi Kaijima, Hitachi (JP); Yoshifumi Kubo, Takahagi (JP); Akitaka Tateishi, Hitachinaka (JP); Katsutoshi Higuma, Takahagi (JP)

Correspondence Address: DICKSTEIN SHAPIRO MORIN & OSHINSKY LLP, 2101 L STREET NW, WASHINGTON, DC, 20037-1526, US

(21) Appl. No.: 10/252,548

(22) Filed: Sep. 24, 2002

(30) Foreign Application Priority Data
Sep. 28, 2001 (JP) 2001-298985

(51) Int. Cl. F02C 6/18

(52) U.S. Cl. 60/39.182; 60/797

(57) ABSTRACT

A power generating plant comprises: a boiler; a steam turbine to be driven with steam generated in the boiler; a power generator to be driven according to the rotation of the steam turbine; a strut for supporting the boiler; a base mounting the steam turbine thereon; and a frame for supporting the base. The steam turbine is disposed above the boiler, and the strut for supporting the boiler is used as the frame. Thus, it is possible to package the steam turbine equipment and the boiler, thereby reducing a construction site for the power generating plant.

### BACKGROUND OF THE INVENTION

The present invention relates to a power generating plant having a boiler and a steam turbine.

In a power generating plant in the prior art, a steam turbine has been generally mounted on a base made of reinforced concrete, and it has been connected to an independent boiler via a steam or water-supplying pipeline.

In recent years, there have been increased a variety of demands for electric power such as the growth of power generating business by utilizing a vacancy in an old factory site or the like or new construction inside an existing power generating plant site of an electric power utility company, as represented by IPP (abbreviating independent power producer), and thus, effective land utilization has been required more than conventional.

The technique for reducing an installation space or shortening the construction time for installation in the conventional power generating plant is disclosed in Japanese Patent Laid-open No. 11-13416. In this publication, there is disclosed a package type power generating plant in which a gas turbine, a power generator and a steam turbine are supported on a base made of a structural steel base and auxiliary machines and pipelines of a control oil system, a lubricant system, a cooling water system and a gaseous hydrogen system for the gas turbine, the power generator and the steam turbine, and electrical instrumentation are incorporated in the inside space of the base made of the structural steel base.

Moreover, Japanese Patent Laid-open No. 2000-161013 discloses a thermal power plant of a vertical constitution, in which a turbine, a power generator to be driven by the turbine and an exhaust gas heat recovery boiler for recovering waste heat from the turbine so as to supply energy to a steam turbine are vertically arranged in sequence and a chimney is disposed further above in a required height in order to remarkably reduce the area of a construction site.

However, no exhaust gas heat recovery boiler is described in the above-described Japanese Patent Laid-open No. 11-13416. An exhaust gas heat recovery boiler is normally disposed independently of the steam turbine or the like, and therefore, is connected to the steam turbine or the like via a steam or water supplying pipeline. As a consequence, the steam or water-supplying pipeline for connecting the boiler with the steam turbine is liable to inconveniently become long. An increase in temperature or pressure of the steam has proceeded according to high efficiency or high output of power generation in recent years, and thus, a cost relevant to the steam or water-supplying pipeline which can cope with the increase in temperature or pressure of the steam cannot be negligible.

In addition, although Japanese Patent Laid-open No. 2000-161013 discloses the power generating plant of the vertical constitution, in which the steam or water supplying pipeline for connecting the boiler with the steam turbine is liable to inconveniently become long since the boiler and the steam turbine are configured to be separated from each other, like in the power generating plant disclosed in the above-described Japanese Patent Laid-open No. 11-13416. Moreover, since in the power generating plant disclosed in Japanese Patent Laid-open No. 2000-161013, the turbine, the power generator and the exhaust gas heat recovery boiler are stereoscopically arranged in a vertical direction, a stereoscopic height is required.

### SUMMARY OF THE INVENTION

Accordingly, an object of the present invention is to provide the configuration of a power generating plant capable of reducing an installation space for power generating equipment and shortening a steam pipeline or the like between a boiler and a steam turbine.

In order to achieve the above-described object, a power generating plant according to the present invention is configured such that a steam turbine is positioned above a boiler and a frame for supporting a base of the steam turbine is formed by the use of a strut for supporting the boiler. With this configuration, it is possible to reduce the installation area, and further, to shorten a steam pipeline or the like for connecting the boiler with the steam turbine.

Specific examples of the configuration include:

(1) A base made of a structural steel base reinforced with a steel frame is used in place of a conventional base made of reinforced concrete, and it is partly integrated with a steel-frame column of a boiler, so that steam turbine equipment having a steam turbine and a power generator is disposed above the boiler in a packaged manner.

(2) In the above-described package type power generating plant, the boiler is an exhaust gas heat recovery boiler that utilizes exhaust gases from a gas turbine as a heat source.

(3) In the above-described package type combined power generating plant, gas turbine equipment also is disposed above the exhaust gas heat recovery boiler in a packaged manner, like the steam turbine equipment (inclusive of the power generator).

As described above, it is possible to save the installation space for the steam turbine equipment in the power generating plants (1) and (2) and the installation space for the steam turbine equipment (inclusive of the power generator) and the gas turbine equipment in the power generating plant (3) with respect to the installation space required in the prior art, and further, to remarkably shorten the steam pipeline for connecting the boiler or the exhaust gas heat recovery boiler with the steam turbine.

### BRIEF DESCRIPTION OF THE DRAWINGS

Other objects and advantages of the invention will become apparent from the following description of embodiments with reference to the accompanying drawings in which:

FIG. 1 is a view showing the configuration of a power generating plant in a preferred embodiment according to the present invention;

FIG. 2 is a cross-sectional view of the power generating plant, as viewed in an axial direction of a steam turbine, in the preferred embodiment according to the present invention;

FIG. 3 is a plan view of the power generating plant, as viewed from the top, in the preferred embodiment according to the present invention;

FIG. 4 is a cross-sectional view of a power generating plant in the prior art, as viewed in an axial direction of a steam turbine; and

FIG. 5 is a view showing the configuration of a power generating plant in another preferred embodiment according to the present invention.

### DETAILED DESCRIPTION OF THE PREFERRED EMBODIMENTS

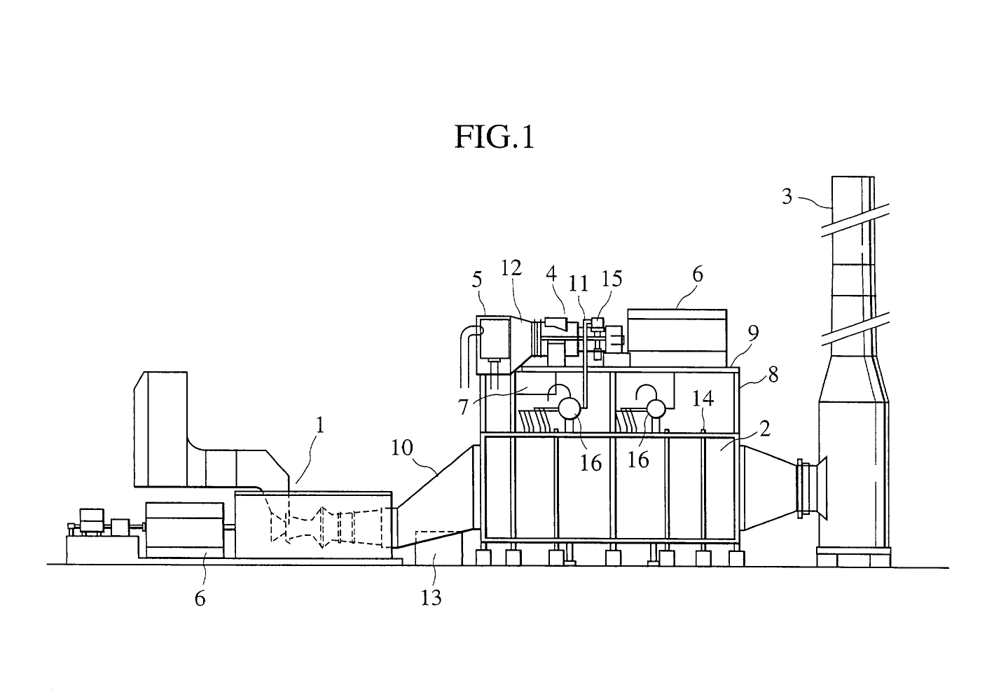

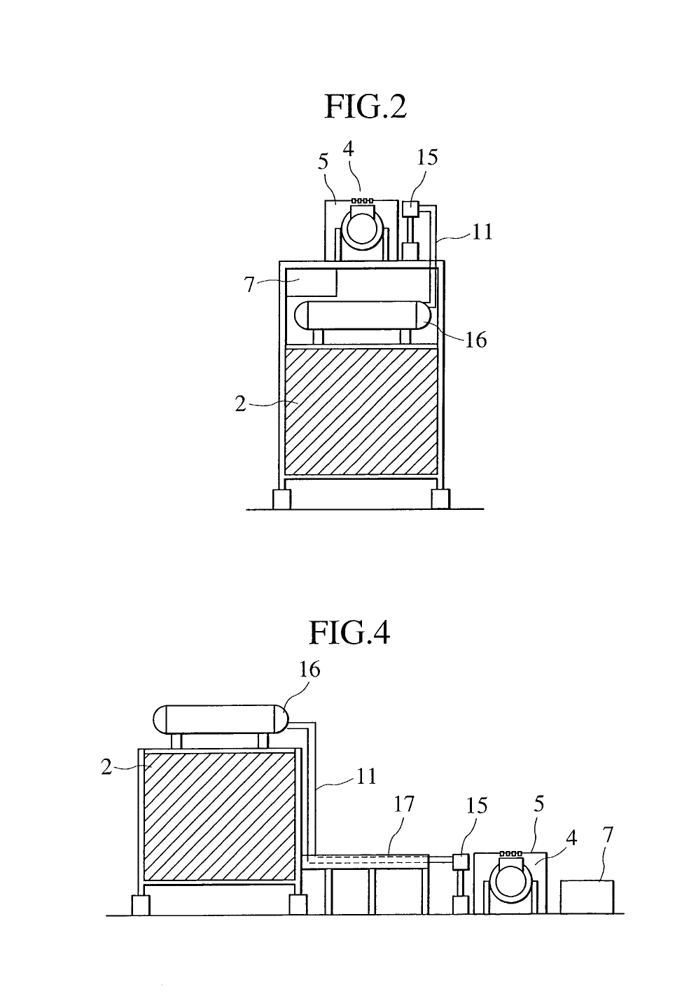

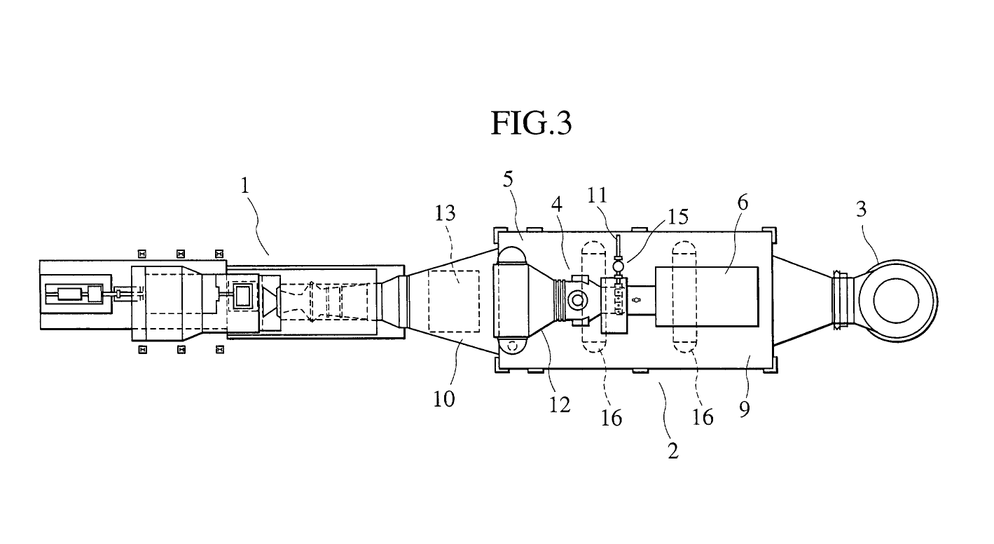

A package type combined power generating plant in a preferred embodiment according to the present invention will be described below in reference to FIGS. 1 to 3. FIG. 1 is a view showing the configuration of steam turbine equipment disposed above an exhaust gas heat recovery boiler in a preferred embodiment according to the present invention; FIG. 2 is a cross-sectional view of the power generating plant, as viewed in an axial direction of a steam turbine; and FIG. 3 is a plan view showing the configuration of the power generating plant in the preferred embodiment according to the present invention. In addition, FIG. 4 is a cross-sectional view showing the configuration of a power generating plant in the prior art, as viewed in an axial direction of a steam turbine.

The combined power generating plant of a package type comprises: gas turbine equipment 1 for burning compressed air and liquid or gaseous fuel and rotating a turbine, thereby generating electricity; an exhaust gas heat recovery boiler 2 for producing steam with high-temperature exhaust gases generated by the gas turbine equipment 1; a flue 3 attached to the exhaust gas heat recovery boiler 2, for discharging the exhaust gases passing through the exhaust gas heat recovery boiler 2 to the atmosphere; a steam turbine 4 to be driven by the steam generated by the exhaust gas heat recovery boiler 2; a steam condenser 5 attached to the steam turbine 4, for condensing the used steam; a power generator 6 to be driven according to the rotation of the steam turbine 4; and auxiliary machines 7 for controlling, lubricating, cooling and the like the steam turbine 4. The steam turbine equipment including the steam turbine 4, the power generator 6, the auxiliary machines 7 and the like is supported by and disposed on or in a base made of a structural steel base constituted of a steel frame 8 and a structural steel base 9, above the exhaust gas heat recovery boiler 2.

The high-temperature exhaust gases generated by the gas turbine equipment 1 is fed to the exhaust gas heat recovery boiler 2 through an exhaust duct 10, to be thermally exchanged with water, and then, is discharged to the atmosphere through the flue 3. The steam turbine 4 is disposed above the exhaust gas heat recovery boiler 2, so that the steam produced by the exhaust gas heat recovery boiler 2 is fed from a steam-water drum 16 to a main shutoff valve 15 disposed right above a steam pipeline 11 therethrough. The steam, which has worked in the steam turbine 4, is discharged in an axial direction, passes through a diffuser 12, and then, is liquefied in the steam condenser 5. Thereafter, the resultant water is fed again to the exhaust gas heat recovery boiler 2 by a pump 13. In this case, part of a steel-frame strut 14 for supporting the exhaust gas heat recovery boiler 2 extends upward to the structural steel base 9 for supporting the steam turbine equipment positioned above the exhaust gas heat recovery boiler 2, and therefore, is partly integrated with the steel frame 8 for supporting the steam turbine equipment. In this manner, the steam turbine equipment and the exhaust gas heat recovery boiler 2 are packaged.

Consequently, it is possible to dispense with the installation space for the steam turbine equipment, which has been required in the prior art. In the case of the independent installation in the prior art, the steam pipeline 11 for connecting the exhaust gas heat recovery boiler 2 with the steam turbine 4 extends from the steam-water drum 16 downward in the vicinity of the ground, and then, is introduced up to the steam turbine 4 by the use of a pipeline rack 17. In contrast, according to the present invention, since the exhaust gas heat recovery boiler 2 and the steam turbine 4 are disposed adjacently to each other, the steam pipeline 11 can be remarkably shortened. Furthermore, the base of the steam turbine 4 can be fabricated at the same time during the assembling work of the exhaust gas heat recovery boiler 2, thus contributing to the shortage of a construction time and the reduction of a construction cost.

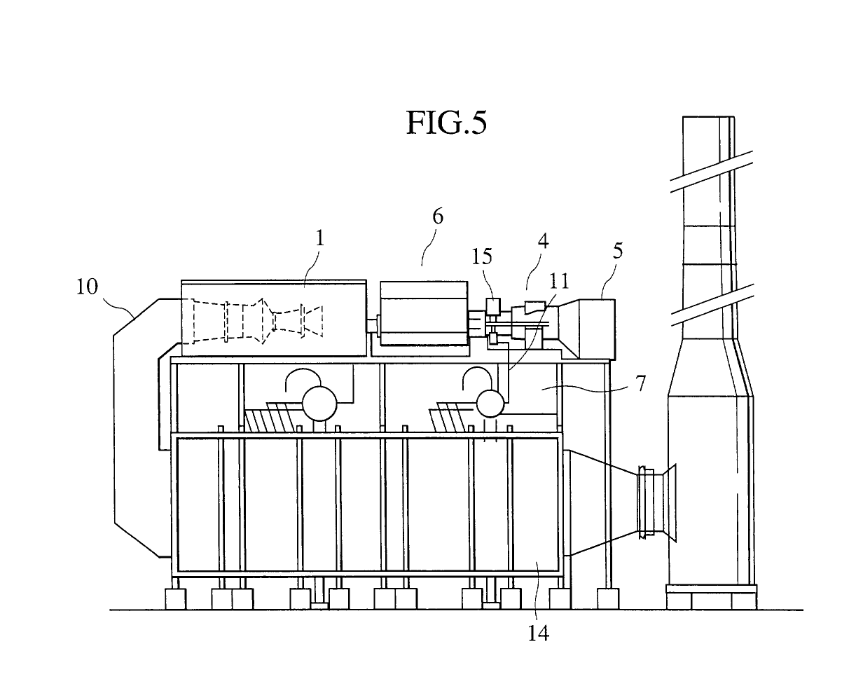

Next, a uni-axial combined power generating plant of a package type in another preferred embodiment according to the present invention will be explained in reference to FIG. 5. FIG. 5 is a view showing the configuration in which gas turbine equipment and steam turbine equipment are disposed above an exhaust gas heat recovery boiler. The uni-axial combined power generating plant of a package type comprises: gas turbine equipment 1 for burning compressed air and liquid or gaseous fuel and rotating a turbine, thereby generating electricity; an exhaust gas heat recovery boiler 2 for producing steam with high-temperature exhaust gases generated by the gas turbine equipment 1; a flue 3 attached to the exhaust gas heat recovery boiler 2, for discharging the exhaust gas passing through the exhaust gas heat recovery boiler 2 to the atmosphere; a steam turbine 4 to be driven by the steam generated by the exhaust gas heat recovery boiler 2; a steam condenser 5 attached to the steam turbine 4, for condensing the used steam; a power generator 6 to be driven according to the rotation of the steam turbine 4; and auxiliary machines 7 for controlling, lubricating, cooling and the like the steam turbine 4. The gas turbine equipment 1, the steam turbine 4, the power generator 6 and the steam condenser 5 are uni-axially connected to each other, and are supported by and disposed on a base made of a structural steel base constituted of a steel frame 8 and a structural steel base 9 above the exhaust gas heat recovery boiler 2. In this case, the steel frame 8 for supporting the steam turbine equipment is partly integrated with a steel-frame strut 14 for supporting the exhaust gas heat recovery boiler 2, and further, the gas turbine equipment 1, the steam turbine 4 and the exhaust gas heat recovery boiler 2 are packaged.

Consequently, it is possible to save the installation spaces for the gas turbine equipment 1 and the steam turbine equipment, which have been required in the prior art, and to remarkably shorten a steam pipeline 11 for connecting the exhaust gas heat recovery boiler 2 with the steam turbine 4. Furthermore, the base of the steam turbine 4 can be fabricated at the same time during the assembling work of the exhaust gas heat recovery boiler 2, thus contributing to the shortage of a construction time and the reduction of a construction cost.

Although in the above-described embodiments, the exhaust gas heat recovery boiler and the steam turbine (or the steam turbine and the gas turbine) are assembled and packaged on the base made of the structural steel base, the boiler, the steam turbine or the like may be installed on the base made of the structural steel base in the plant installation site, as required. Otherwise, the boiler may be assembled on the base made of the structural steel base, the steam turbine or the like may be installed on the base made of the structural steel base in the plant installation site, as required. However, the packaged configuration is more advantageous to the shortage of a construction time and the reduction of a construction cost in the power generating plant which can be integrally transported, like in the above-described embodiments.

According to the present invention, it is possible to produce the effects of reducing the installation space for the power generating equipment and shortening the steam or water supplying pipelines.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A power generating plant comprising:
a boiler;
a steam turbine to be driven with steam generated in the boiler;
a power generator to be driven according to the rotation of the steam turbine;
a strut for supporting the boiler;
a base mounting the steam turbine thereon; and
a frame for supporting the base;
wherein the steam turbine is disposed above the boiler, and the strut for supporting the boiler is used as the frame.

2. A power generating plant as claimed in claim 1, wherein the base is a structural steel base, on which the steam turbine and the power generator are mounted, the frame is a steel frame for supporting the structural steel base, the steam turbine and the power generator are disposed above the boiler, and the strut for supporting the boiler is used as the steel frame.

3. A power generating plant as claimed in claim 2, wherein the boiler, the steam turbine and the power generator are packaged.

4. A steel-frame base for a power generating plant including a boiler, a steam turbine to be driven with steam generated in the boiler, and a power generator to be driven according to the rotation of the steam turbine, the steel-frame base for a power generating plant comprising:
a strut for supporting the boiler;
a structural steel base mounting the steam turbine and the power generator thereon; and
a steel frame for supporting the structural steel base;
wherein the steel frame is configured by utilizing the strut for supporting the boiler in such a manner that the steam turbine and the power generator are disposed above the boiler.

5. A boiler structure for a power generating plant comprising:
a boiler;
a strut for supporting the boiler;
a steel frame configured by utilizing the strut; and
a structural steel base mounting thereon a steam turbine to be driven with steam generated in the boiler and a power generator to be driven according to the rotation of the steam turbine;
wherein the structural steel base is supported by the steel frame configured by utilizing the strut.

6. A power generating plant as claimed in claim 1, wherein the power generating plant is a combined power generating plant having gas turbine equipment including a gas turbine and a power generator to be driven according to the rotation of the gas turbine, and the boiler is an exhaust gas heat recovery boiler for generating steam with exhaust gases from the gas turbine.

7. A power generating plant as claimed in claim 1, wherein the power generating plant is a combined power generating plant having a gas turbine so as to transmit the rotating drive of the gas turbine to the power generator, the boiler is an exhaust gas heat recovery boiler for generating steam with exhaust gas from the gas turbine, and the gas turbine is mounted on the base.

8. A steel-frame base for a power generating plant as claimed in claim 4, wherein the power generating plant includes a gas turbine; the boiler is an exhaust gas heat recovery boiler for generating steam by utilizing the heat of exhaust gases from the gas turbine; the steam turbine is a steam turbine to be driven with steam from the exhaust gas heat recovery boiler; the power generator is a power generator to be driven according to the rotation of the gas turbine and the steam turbine; the strut supports the exhaust gas heat recovery boiler; the gas turbine, the steam turbine and the power generator are mounted on the structural steel base; and the steel frame is configured by utilizing the strut for supporting the exhaust gas heat recovery boiler in such a manner that the gas turbine, the steam turbine and the power generator are disposed above the boiler.

9. A boiler structure for a power generating plant as claimed in claim 5, wherein the boiler is an exhaust gas heat recovery boiler for generating steam by utilizing the heat of exhaust gases from the gas turbine; the gas turbine, the steam turbine to be driven with the steam generated in the exhaust gas heat recovery boiler and the power generator to be driven according to the rotation of the gas turbine and the steam turbine are mounted on the structural steel base; and the structural steel base is designed to be supported by the steel frame configured by utilizing the strut.

10. A package type power generating plant comprising:
a boiler for generating steam;
a steam turbine to be driven with steam generated in the boiler;
a power generator connected to the steam turbine via a shaft, to be driven according to the rotation of the steam turbine; and
a structural steel base mounting thereon the steam turbine and the power generator;
wherein the structural steel base is supported by a steel frame in such a manner as to be positioned above the boiler.

11. A package type combined power generating plant as claimed in claim 10, wherein the power generating plant includes gas turbine power generating equipment having a gas turbine for burning liquid or gaseous fuel together with compressed air so as to generate high-temperature exhaust gases and a power generator to be driven according to the rotation of the gas turbine; the boiler is an exhaust gas heat recovery boiler for thermally exchanging the high-temperature exhaust gases in the gas turbine so as to generate steam; and the structural steel base is supported by the steel frame in such a manner as to be positioned above the exhaust gas heat recovery boiler.

12. A package type combined power generating plant as claimed in claim 10, wherein the power generating plant includes a gas turbine for burning liquid or gaseous fuel together with compressed air so as to generate high-temperature exhaust gases; the boiler is an exhaust gas heat recovery boiler for thermally exchanging the high-temperature exhaust gases in the gas turbine so as to generate steam; the power generator is a power generator connected to the gas turbine and the steam turbine via a shaft, to be driven according to the rotation of the shaft; and the structural steel base is a structural steel base which mounts thereon the gas turbine, the steam turbine and the power generator and is supported by a steel frame in such a manner as to be positioned above the exhaust gas heat recovery boiler.
